(19) United States
(12) Patent Application Publication
(10) Pub. No.: US 2025/0174910 A1
(43) Pub. Date: May 29, 2025

(54) WIDEBAND RECONFIGURABLE BIAS ISOLATION FOR INTELLIGENT REFLECTIVE SURFACES WITH RADIO-FREQUENCY CHOKE

(71) Applicant: Dell Products L.P., Round Rock, TX (US)

(72) Inventors: Tejinder Singh, Kanata (CA); Kan Wang, Ottawa (CA); Navjot Kaur Khaira, Kanata (CA); Morris Repeta, Ottawa (CA)

(21) Appl. No.: 18/523,315

(22) Filed: Nov. 29, 2023

(51) Int. Cl. H01Q 21/00; H04B 7/04

(52) U.S. Cl. CPC H01Q 21/0093; H04B 7/04013

(57) ABSTRACT

A reconfigurable intelligent surface is disclosed. The reconfigurable intelligent surface includes unit cells that include banks of capacitors that are integrated into the structure of the surface. The banks of capacitors provide bias isolation and reconfigurable impedance matching. The configurability of the capacitance can impact the reactance and allow for operation over a wider range of frequencies.

### FIELD OF THE INVENTION

Embodiments of the present invention generally relate to reconfigurable intelligent surfaces. More particularly, at least some embodiments of the invention relate to systems, hardware, software, computer-readable media, and methods for reconfigurable intelligent surfaces with radio-frequency choke.

### BACKGROUND

Many operating networks are based on 5G technologies. Notwithstanding the benefits of 5G technologies, the demand for high-speed and reliable connectivity that will enable a wider range of applications such as autonomous vehicles, smart cities, Internet of Things (IoT) devices, augmented reality, and more continues to grow. Thus, the pursuit of newer technologies, such as 5G-Adv and 6G networks, continues. These networks are intended to provide faster data speeds, lower latencies, increased capacity, and better performance compared to earlier generations.

Software controlled metasurfaces, such as reconfigurable intelligent surfaces, have the ability to enhance the performance and capabilities of networks such as 5G-Adv. and 6G networks. A reconfigurable intelligent surface includes a number of small elements or units that can manipulate the propagation of electromagnetic waves. By intelligently adjusting the reflection and/or transmission properties of these elements, a reconfigurable intelligent surface can often redirect the wireless signals in desired directions.

The reconfigurability of a reconfigurable intelligent surface may be achieved with the assistance of RF (Radio Frequency) components such as varactor diodes and PIN diodes. The integration of RF components with varying biasing requirements within the same system introduces complexities in ensuring proper isolation and minimizing unwanted coupling effects. More specifically, one challenge with these RF components is that there is a need to isolate a DC (Direct Current) bias line or path and the RF signal path to prevent radio or electromagnetic interference.

In reconfigurable intelligent surfaces, the DC biasing circuitry is responsible for providing the necessary bias voltage or current to control the behavior of the RF components, such as varactor diodes or PIN diodes, which affect the properties of the reflected signals. On the other hand, the RF signal path carries the high-frequency signals that need to be manipulated or modulated by the reconfigurable elements of the reconfigurable intelligent surface. The coexistence of these two paths within the same system can lead to undesired interactions and interference, compromising the overall performance and reliability of the reconfigurable intelligent surface.

The presence of the biasing circuitry can introduce unwanted coupling between the DC and RF paths. This can result in signal distortion, power losses, and limited reconfigurability. Furthermore, variations in the biasing conditions may affect the impedance and performance of the RF components. These factors make it challenging to maintain consistent and reliable operation.

To address these issues, various techniques and circuit designs may ensure proper isolation with respect to the DC bias and RF signal paths. These techniques may involve the use of specialized components, such as RF chokes, filters, or radial stubs to perform the desired signal isolation. However, the relatively small size of unit cells in a reconfigurable intelligent surface makes conventional isolation solutions difficult to implement. FIG. 5 illustrates examples of isolating bias lines a unit cell of a reconfigurable intelligent surface. FIG. 5 illustrates an example of an RF choke 502 and of a radial stub 504. As illustrated, the RF choke 502 has size requirements that may exceed the size of the unit cell. The radial stub 504 is illustrated for a single bias line. However, multiple bias lines may be present and size constraints prevent the effective use of radial stubs such as the radial stub 504.

More specifically, RF chokes, generally, are commonly employed to block the flow of DC current while allowing RF signals to pass through. They are typically implemented using inductors or ferrite beads. RF chokes can effectively prevent DC bias from entering the RF circuitry, ensuring proper operation of the reconfigurable intelligent surface. However, they occupy a significant amount of physical space due to the need for multiple windings or larger-sized ferrite cores. This limits the miniaturization and compactness of the reconfigurable intelligent surface.

Radial stubs, on the other hand, are passive components that provide high impedance at the DC bias frequency, effectively blocking the DC current, while allowing RF signals to pass through. They may be used in reconfigurable intelligent surface application due to their ability to be monolithically integrated as illustrated in FIG. 5. However, they consume considerable space. In examples requiring at least two bias lines, this generates a need for two radial stubs for each of the bias lines. It is extremely challenging implement radial stubs given the area constraints. This configuration may also significantly interfere with the electrical field pattern on the ground plane if a single layer is used. This leads to reduced performance, or increased design difficulty and cost for multilayer implementations.

In essence, RF chokes and radial stubs are commonly used technologies for blocking DC current in reconfigurable intelligent surface applications, but they present challenges in terms of area consumption and power consumption. RF chokes require significant physical space, limiting miniaturization possibilities. Radial stubs, although effective in blocking DC current, can consume substantial power due to the need for termination resistors.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a panel or a reconfigurable intelligent surface that includes an arrangement of unit cells;

FIG. 2 discloses aspects of a unit cell including bias lines and capacitor banks;

FIG. 3A discloses additional aspects of a capacitor bank implemented or integrated with a unit cell;

FIG. 3B discloses aspects of a transmission line that include multiple chokes.

FIG. 4A illustrates a perspective view of an example unit cell;

FIG. 4B illustrates a top view and a bottom view of an example unit cell;

FIG. 4C discloses aspects of a signal path in an example unit cell;

FIG. 5 discloses aspects of isolating bias lines in a unit cell of a reconfigurable intelligent surface; and

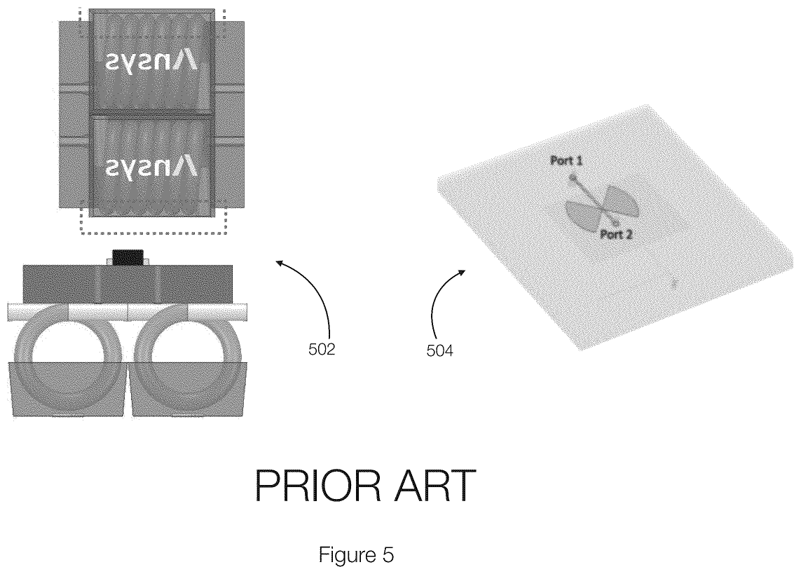

FIG. 6 discloses aspects of a computing device, system, or entity.

### DETAILED DESCRIPTION OF SOME EXAMPLE EMBODIMENTS

Embodiments of the present invention generally relate to reconfigurable intelligent surfaces. More particularly, at least some embodiments of the invention relate to systems, hardware, software, computer-readable media, and methods for reconfigurable bias isolation in reconfigurable intelligent surfaces or system.

Bias isolation can prevent radio-frequency (RF) signal leakage through direct current (DC) bias lines in reconfigurable intelligent surfaces. As previously stated, approaches such as conventional chokes (e.g., RF coils or radial stubs) are difficult to implement in reconfigurable intelligent surfaces due to size constraints.

Embodiments of the invention provide bias isolation using on-chip capacitors that are integrated into the structure of the reconfigurable intelligent surface as a reconfigurable matching network. In one embodiment, a monolithic structure of a reconfigurable intelligent surface is disclosed that includes a capacitor based approach to bias isolation. The on-chip capacitors may be arranged in capacitor banks whose capacitance can be varied. Multiple capacitor banks may be provided. The capacitor banks do not suffer from the size constraints of other isolation techniques.

In one example, the capacitance of the capacitor banks can be varied using switches such as chalcogenide alloys. Chalcogenide alloys are examples of materials that can switch from high resistance states (e.g. insulative) to low-resistance states (e.g., metallic). The state may be changed by applying a voltage or voltage pulse. Once this type of material is switched to a particular state, the state remains constant until a subsequent voltage pulse is received. Thus, chalcogenide switches can be switched on/off with little power consumption.

Embodiments of the invention, more specifically, relate to bias line isolation in the unit-cell design of a reconfigurable intelligent surface. By monolithically integrating an RF choke using capacitors, RF signal leakage through the bias line is effectively prevented or suppressed, thereby achieving bias isolation. The use of materials, such as chalcogenide alloys (e.g., germanium antimony telluride (GST)), offers advantages including negligible power consumption and reduced design complexity.

Embodiments of the invention relate to configuring on-chip capacitors as RF chokes, eliminating the challenges associated with alternative RF choke implementations such as coil and radial stub implementations. Additionally, the embodiments of the invention relate to bias isolation that incorporates a switchable matching network. This advantageously introduces reconfigurability to a unit cell and to the reconfigurable intelligent surface and increases the bandwidth.

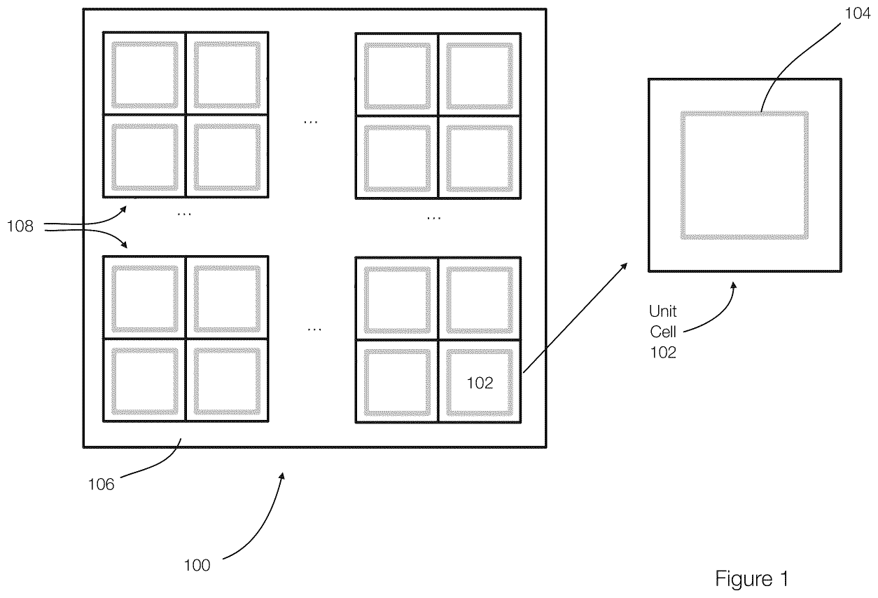

FIG. 1 discloses aspects of a panel or of a reconfigurable intelligent surface. The surface or panel 100, which may be formed monolithically or formed using deposition, etching, and other techniques, includes a substrate 106 and an array 108 or other configuration of unit cells formed on a surface of the substrate 106. The unit cells, represented by the unit cell 102, each include a metal element 104.

The metal element 104 of the unit cell 102, which may be formed of copper, is independent of other metal elements on other unit cells in the array 108. The metal element 104 is typically arranged in a pattern (FIG. 1 illustrates a square metal element). The pattern may be sized, shaped, or otherwise arranged to be resonant with a particular frequency or range of frequencies. In one example, embodiments of the invention enable the panel 100 to be responsive to multiple frequencies or a range of frequencies.

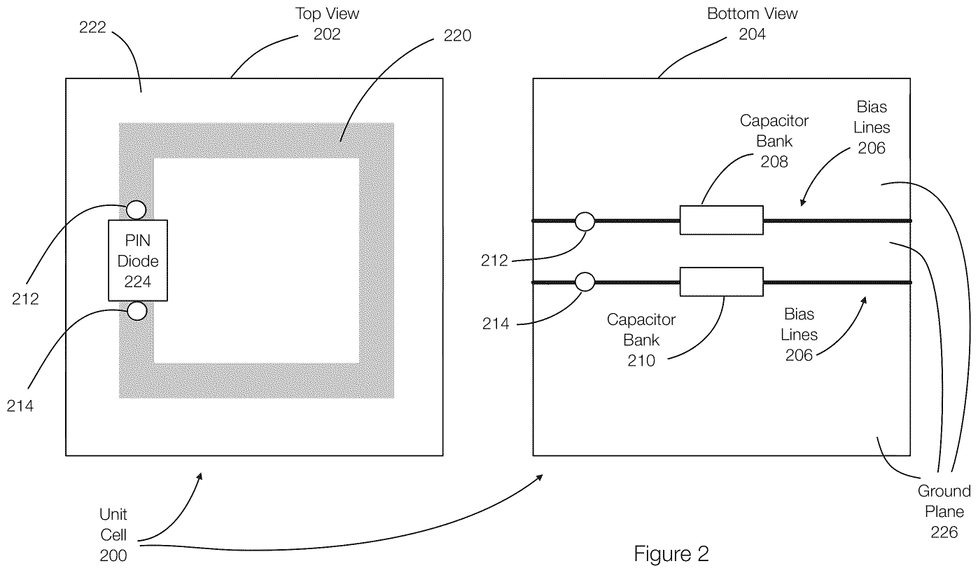

FIG. 2 discloses additional aspects of a unit cell and includes a top view and a bottom view of a unit cell. More specifically, FIG. 2 illustrates a top view 202 and a bottom view 204 of a unit cell 200, which may be an example of the unit cell 101. A metal element 220 is formed on a surface of a substrate 222. In this example, a PIN diode 224 is included or integrated with the unit cell 200. The bias lines 206 may be used to control the behavior of RF (Radio Frequency) components, such as the PIN diode 224. These RF components are used to control the properties of the signals reflected by the panel 100 or by the unit cell 200. In one example, the PIN diode 224 operates as a switch and is controlled using the bias lines 206.

In one example, the PIN diode 224 requires power (e.g., for biasing), which is provided via bias lines 206. The bias lines 206 which are illustrated in the bottom view 204. The PIN diode 224 (or other element such as varactor diode) is connected to the bias lines 206 using vias 212 and 214. At the same time, the RF signal path (e.g., the metal element 220) carries high-frequency signals to be manipulated by the RF components such as the PIN diode 224 and the metal layer 220.

The coexistence of an RF signal path (e.g., the metal layer 220) and a bias path (e.g., bias lines 206 and vias 212, 214) on the unit cell 200 can lead to undesired interactions and interference such as coupling. These interactions and interference can compromise the overall performance and reliability of the reconfigurable intelligent surface. The presence of the biasing circuitry can result in signal distortion, power losses, and limited reconfigurability. Further, variations in the biasing conditions may impact the impedance and performance of the RF components.

Embodiments of the invention operate to prevent or reduce unwanted coupling or other interference in the unit cell 200. In one example, a choke is provided in the unit cell 200 or integrated with the unit cell 200. The capacitor banks 208 and 210 are each examples of a choke. In this example, the capacitor banks 208 and 210 are configurable and may include various arrangements of individual capacitors that can be individually selected and/or selectively combined. This allows desired impedance matching conditions to be achieved.

In impedance matching, one goal is to minimize the reflection of the signal and maximize the power transfer between a source and a load. Capacitors have the ability to store and release electrical energy and can be used to adjust the reactive component of the impedance. The capacitor banks 208 and 210 allow a wide range of effective capacitance options to be selected. The capacitors in the capacitor banks 208 and 210 can be arranged or combined in series or parallel configurations. The bottom view illustrates a ground plane 226 of the unit cell 200 in the bottom view 204. The capacitor banks 208 and 210 may be formed using metallic layers in the structure and the ground plane 226.

As illustrated in FIG. 2, an electromagnetic signal may be coupled into the bias lines 206. The capacitor banks 208 and 210 can be configured to impact the reactance and thus the impedance a transmission line. By setting a capacitance of the capacitance banks to achieve impedance matching, any RF signal present in the metal layer 220 can be isolated from the DC bias lines 206. In one embodiments, embodiments of the invention provide a choke (e.g., the capacitor banks 208 and 210) that has a selectable impedance or reactance.

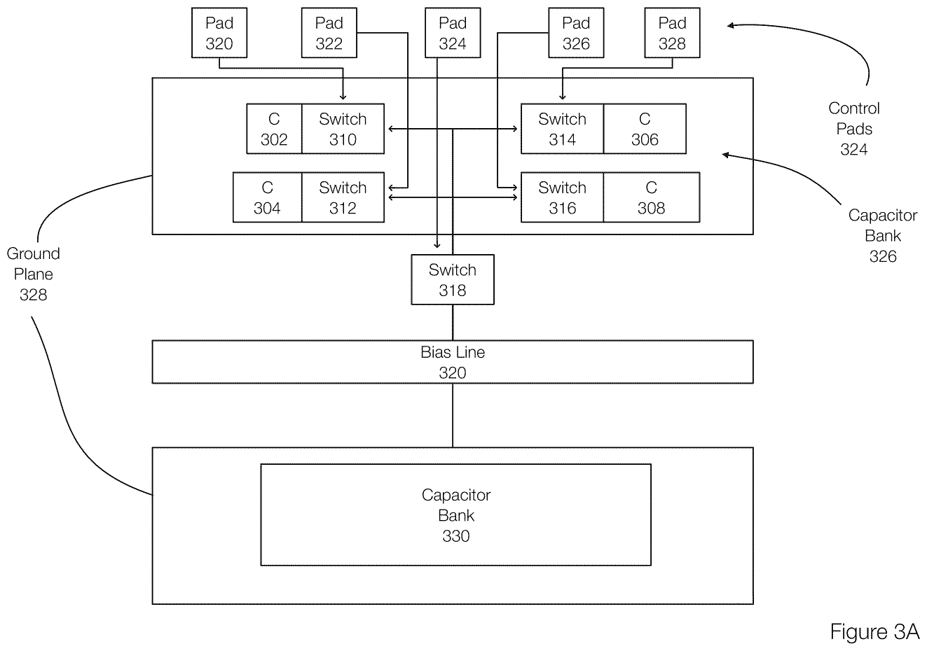

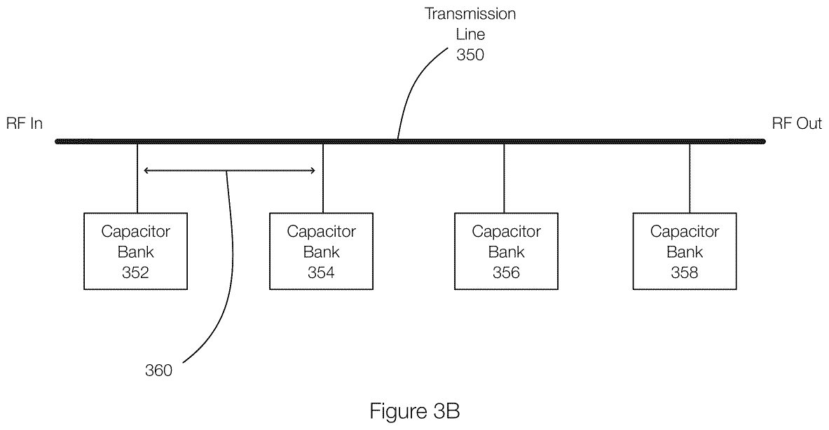

FIG. 3A discloses aspects of a choke or a capacitor bank implemented or integrated with a unit cell. In one example, each unit cell of a reconfigurable intelligent surface may include a choke or capacitor bank such as illustrated in FIG. 3A. Multiple capacitor banks may be fabricated into the unit cell 200.

In one example, a unit cell may be associated with two bias lines 206, such as illustrated in FIG. 2. In one example, a ground plane 226 is present on both sides of each of the bias lines 206. In one example, multiple capacitor banks may be formed on both sides of each bias line.

FIG. 3A thus illustrates a single bias line 320 with capacitor banks 326 and 330 formed relative to the ground plane 328 on both side of the bias line 320 in this example. Multiple capacitor banks may be formed on both sides of multiple transmission lines in some embodiments.

The capacitor bank 326 may include n capacitors (4 in this example). The capacitors 302, 304, 306, and 308 may each be formed using metal plates (one of which is the ground plane) that are separated by a dielectric or other suitable material. The capacitors 302, 304, 306, and 308 may have the same or different capacitances.

In one example, the capacitor 302 may have a first capacitance. The capacitance of the capacitor 304 is double the capacitance of the capacitor 302. The capacitance of the capacitor 306 is double the capacitance of the capacitor 304. The capacitance of the capacitor 308 is double the capacitance of the capacitor 306.

The capacitor bank 326 is connected to the bias line 320 with a switch 318. The switch 318 is controlled via a pad 324. Similarly, the capacitors 302, 304, 306, and 308 are associated, respectively, with switches 310, 312, 314, and 316. The capacitors 302, 304, 306, and 308 are controlled using the associated switches 310, 312, 314, and 316 the pads 320, 322, 326, and 328 as illustrated in FIG. 3A.

The switch 318 may be used to connect or disconnect the capacitor bank 326 to the bias line 320. The switches 310, 312, 314, and 316 determine which of the capacitors 302, 304, 306, and 308 contribute to the impedance or reactance.

Thus, the capacitor bank 326, in one example, includes a number of capacitors with discrete values that are grouped together for the purpose of impedance matching. The capacitor bank 326 provides a range of capacitance values that can be selectively combined to achieve the desired matching conditions.

In impedance matching, the goal is to minimize the reflection of the signal and maximize the power transfer between the source and the load. Capacitors, with their ability to store and release electrical energy, can be used to adjust the reactive component of the impedance. By using the capacitor bank 326 (and/or 330), which include multiple capacitors with different capacitance values, a wide range of effective capacitance options can be generated. The capacitor values can be combined in parallel or series configurations.

The capacitance value of the selected capacitor(s) determines the reactance seen by the signal and thus influences the impedance seen by the signal. By strategically selecting and configuring the capacitors in the capacitor bank 326 and/or the capacitor bank 330, the impedance can be adjusted to match a desired impedance value. The capacitor banks 326 and 330 allow for allows for efficient and effective matching of the impedance between the source and load, enabling improved signal transmission and system performance.

In one example, the switches 310, 312, 314, and 316 are formed using a material that can be changed from a conductive state (or low resistance state) to an insulator (or high resistive) state. An example of such a material is a chalcogenide material. Applying a pulse to a chalcogenide material can change the state of the material. Once a state has been set, no power is required to maintain the state.

More specifically, chalcogenide materials change state in response to a heat pulse, which may be achieved using a voltage. The pulse required to change from the metallic state to an amorphous or insulative state may be different from the pulse required to change from the amorphous state to the metallic state. Generally, the pulse required to change from the amorphous state to the metallic state may require a lower temperature and a longer time. However, both state transitions can be achieved in less than 1 nanosecond in one example.

Thus, using a chalcogenide material for the switches 310, 312, 314, 316, and 318 allows a specific capacitance to be connected/disconnected to the bias line 320.

The capacitor bank 330 may be similarly configured or may include capacitances of different values. This may increase the capacitance values that can be added to the bias line 320.

FIG. 3B discloses aspects of a transmission line that include multiple chokes. The bottom view 204 illustrates a single capacitor bank (banks 208 and 210): one in each of the transmission lines 206. However, FIG. 3B illustrates that a transmission line may be associated with multiple chokes of capacitance banks. FIG. 3B illustrates a transmission line 350 that has an RF In and an RF Out. In this example, multiple capacitor banks (represented by capacitor banks 352, 354, 356, and 358) are connected to the transmission line 350. The capacitor banks are separated by a fixed sized line segment 360 in one example. The inclusion of multiple banks further expands the reconfigurability of the impedance or reactance of a unit cell and allows a reconfigurable intelligent surface to operate with additional bandwidth.

More specifically, a reconfigurable matching network implemented by a number of capacitor banks can significantly improve the bandwidth of the unit cell by allowing different impedances to be selected and thereby accommodate various frequencies. This approach enables a reconfigurable intelligent surface to operate efficiently over a wider range of frequencies, thereby enhancing its overall bandwidth. By employing multiple capacitor banks, each with a different capacitance value in one example, the matching network can be dynamically adjusted to provide optimal impedance matching at different frequencies. This reconfiguration capability allows the reconfigurable intelligent surface to adapt and respond to various frequency requirements encountered in practical applications. When a specific frequency is targeted, the appropriate capacitor bank(s) can be selected to achieve the desired impedance matching. By matching the impedance between the source and the reconfigurable intelligent surface element, the signal power transfer is maximized, leading to improved performance and enhanced bandwidth.

The ability to reconfigure the matching network for different frequencies offers several benefits. The reconfigurable intelligent surface can operate across a broader frequency range and accommodate various wireless communication systems and standards. The reconfigurable intelligent surface can adapt to changing environmental conditions and interference scenarios, ensuring reliable and efficient signal transmission. By optimizing impedance matching, the reconfigurable matching network helps minimize signal reflections, losses, and distortions, leading to improved overall system performance.

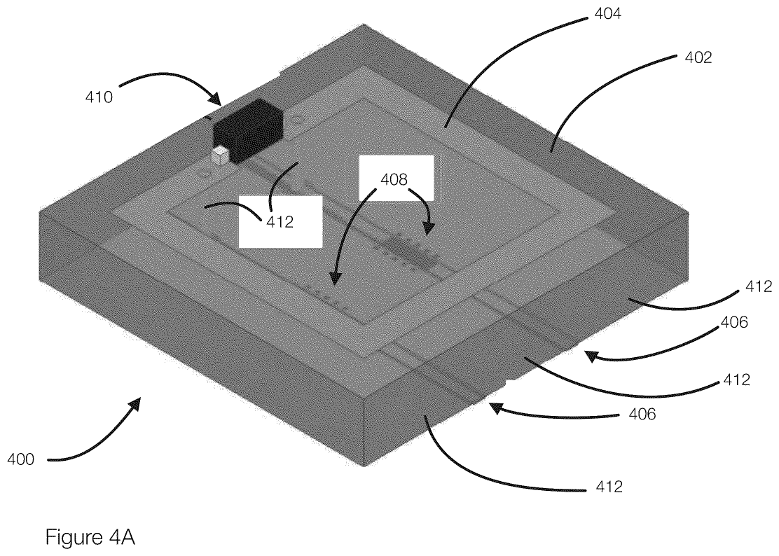

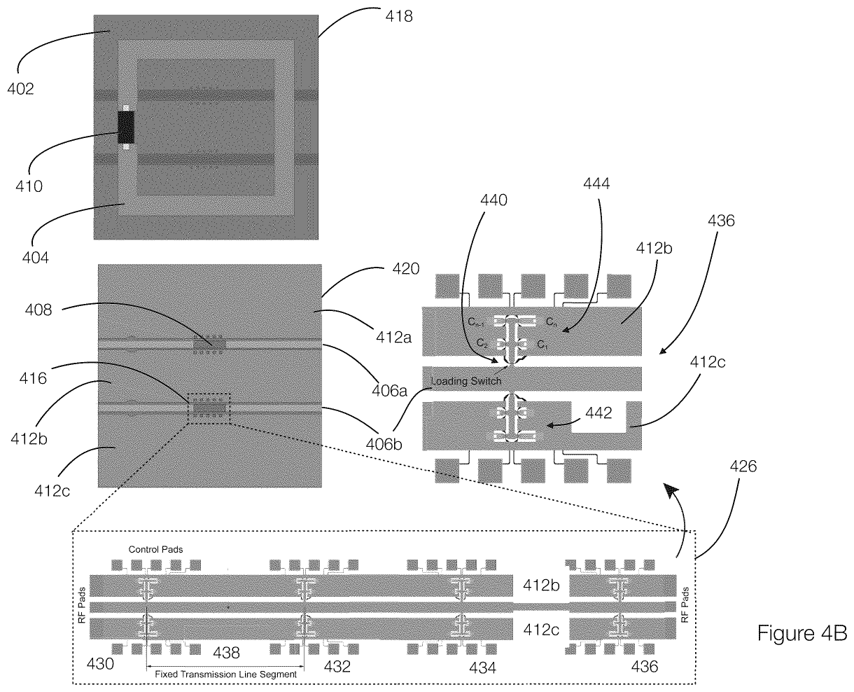

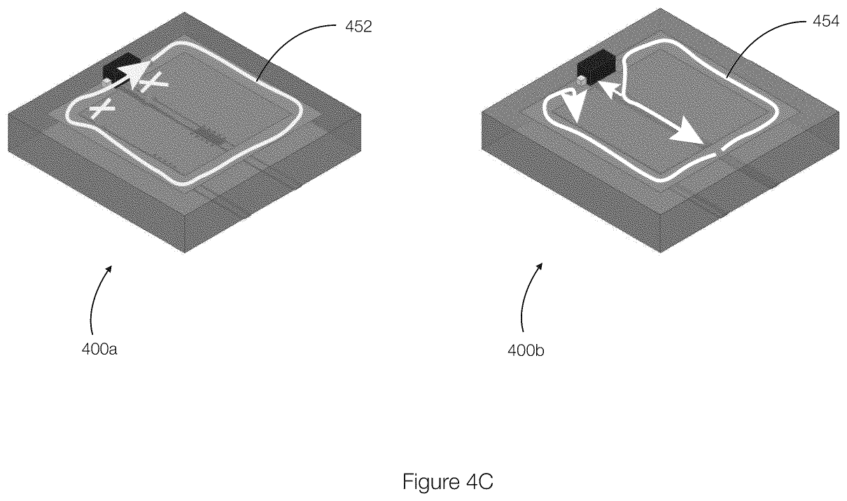

FIG. 4A discloses aspects of a perspective view of example unit cell. FIG. 4 illustrates a unit cell 400 that include a substrate 402. A metal element 404, which is configured to resonate with a frequency or range of frequencies of an incident electromagnetic wave or signal, is formed on a top surface of the substrate 402. In this example, an RF component 410, such as a PIN diode, is connected with the metal element 404. In one example, the RF component 410 may be switched on/off to control operation of the unit cell 400 and more specifically of the metal layer 404.

The RF component 410 is connected to bias lines 406 by vias 412. The bias lines 406 may be used to place a DC voltage across the RF component 410 to control its state (e.g., on/off).

During fabrication, various layers are formed on the bottom surface of the substrate 402. These layers may include a ground plane 412, the bias lines 406, capacitor banks 408, or the like. Thus, appropriate material may be formed, etched, or the like to form capacitors, signal lines, switches or the like. The capacitor banks 408 may act as chokes to isolate the bias lines 406 from the RF signal present in the metal element 404 in response to an incident signal.

FIG. 4B discloses additional aspects of a unit cell using additional views of the unit cell. FIG. 4B illustrates a top view 418 and a bottom view 420 of the unit cell 400. The top view 418 illustrates the substrate 402, the RF component 410 and the metal element 404. The bottom view 420 illustrates the ground plane 412, which is represented as portions 412a, 412b, and 412c, the bias lines 406, represented as bias lines 406a and 406b, a choke 408 and a choke 416. Each of the bias lines 406 is associated with a separate choke in this example.

In this example, the bias line 406a is between the ground plane portions 412a and 412b. The bias line 406b is between the ground plane portions 412b, and 412c. When forming the ground plane 412, the ground plane 412 is separated from the bias lines 406.

The expanded view 426 of the choke 416 is also illustrated. The view 426 illustrates, in this example, that the choke 416 includes multiple capacitor banks 430, 432, 434, and 436 and that the banks are separated by a fixed transmission line segment represented by line segment 438. The expanded view 426 illustrates a portion of the ground plane portions 412b and 412c.

In FIG. 4B, the bank of capacitors 436 illustrated above the expanded view 426 includes capacitors 444. The capacitors 444 are formed relative to the ground plane portion 412b. Capacitors 442 may also be formed over the ground plane portion 412c in the capacitor bank 436. The capacitors 444 and 442 are connected to the bias line 406b through a switch such as the switch 440. The capacitors 442 are similarly connected to the bias line 406b through a switch. This allows the capacitors 444 and 442 in the capacitor bank 436 to be connected/disconnected to the bias line 406b as a group. Further, the flexibility to select a capacitance using the switches associated with the choke 416 allows the unit cell and the reconfigurable intelligent surface to be configured for various frequencies. Thus, one or more of the capacitors 444 can be connected to the bias line 406b as previously described. A capacitor bank as described may include a group of capacitors on one or both sides of the bias or transmission line.

FIG. 4C discloses aspects of a signal path in a unit cell. FIG. 4C illustrates the unit cell 400 of FIG. 4A in a state 400a that includes a choke such as the chokes 408 and 416 and a state 400b without a choke associated with the bias lines. In the state 400a, a particular capacitance has been selected. As a result, the signal 452 does not leak into the bias line due to the impedance matching provided by the chokes 408 and 416. In contrast, the state 400b illustrates that, in the absence of a choke, the signal 454 is not isolated from the bias lines.

As a result, a reconfigurable matching network (e.g., the chokes 408 and/or 416), helps minimize or reduce signal reflections, losses, distortions, and the like and improves performance of the unit cell and of the reconfigurable intelligent surface.

One application that may benefit from reconfigurability and wide bandwidth is wireless communication in indoor environments. In indoor wireless communication systems, there are often challenges related to signal propagation, interference, and coverage for 5G-Adv. and 6G. The use of reconfigurable intelligent surfaces can help overcome these challenges by manipulating the propagation environment through intelligent reflection and reconfigurable beamforming.

The reconfigurability of the reconfigurable intelligent surfaces allows for dynamic adaptation to changing communication conditions. Electrical reconfigurability requires bias line isolation to prevent leakage. For example, in a crowded indoor environment with multiple users and varying channel conditions, the reconfigurable intelligent surfaces can dynamically adjust its reflection properties to optimize signal strength and quality for each user. This reconfigurability enables better coverage, improved signal-to-noise ratio, and increased capacity in the wireless network.

Furthermore, the wide bandwidth capability of reconfigurable intelligent surfaces can provide support for various wireless communication standards and frequency bands simultaneously. With the increasing demand for high-speed data transmission and the proliferation of different wireless technologies, such as Wi-Fi, Bluetooth, and cellular networks, the reconfigurable intelligent surface needs to operate across a wide range of frequencies. By reconfiguring its reflection characteristics and matching network as described herein, a reconfigurable intelligent surface an provide efficient signal reflection and absorption over a broad frequency spectrum, ensuring seamless communication across multiple wireless systems. By combining reconfigurability and wide bandwidth, the RIS can significantly enhance wireless communication in indoor environments. It enables improved coverage, increased capacity, reduced interference, and enhanced signal quality, thereby providing a more reliable and efficient wireless communication experience for users in indoor settings.

Another reconfigurable intelligent surface application that benefits from reconfigurability and wide bandwidth is in the field of radar systems, specifically for target detection and tracking. In radar systems, the ability to accurately detect and track targets is important for various applications such as military surveillance, air traffic control, weather monitoring, and autonomous vehicles. Traditional radar systems often rely on mechanically scanning antennas or phased array antennas, which have limitations in terms of scanning speed, beam agility, and complexity.

By integrating a reconfigurable intelligent surface with reconfigurable properties, the radar system can improve its scanning speed significantly using electrical steering instead of mechanical steering. The reconfigurability allows the reconfigurable intelligent surface to dynamically adjust its reflection characteristics under milli-second range, enabling beamforming and beam steering capabilities. As previously, the existing approaches for bias line isolation occupies so much area that a realistic design is challenging to realize. Embodiments of the invention can ensure electrically fast scanning time with a compact design.

The wide bandwidth capability of the reconfigurable intelligent surface is useful in radar applications where the radar system operates across a broad range of frequencies. Different radar systems may operate in various frequency bands, such as X-band, Ku-band, or millimeter-wave frequencies. The reconfigurable intelligent surface, with its wideband reconfigurable matching networks and reflection properties, can efficiently operate across these frequency ranges with dynamically adjustable bias line isolation, enabling seamless integration with different radar systems and facilitating multi-frequency radar operation. With the integration of a reconfigurable intelligent surface, the radar system can achieve enhanced target detection capabilities, improved tracking accuracy, and increased system flexibility.

Embodiments of the invention may also include a controller (e.g., a computing device, server, or the like), which may include processors, memory, or the like. The controller of computing device, which may be local or remote, may be configured to control the capacitance. The controller may be configured to adjust the capacitance of the capacitor banks by changing the states of the switch. This may be performed based on a signal of interest, to set a specific impedance, or the like.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, signal processing operations, wireless coverage operations, signal steering or reflection operations, wireless coverage operations, radar operations, beam forming operations, impedance matching operations, or the like. More generally, the scope of the invention embraces any operating environment in which the disclosed concepts may be useful.

It is noted that any operation of any of the methods disclosed herein may be performed in response to, as a result of, and/or, based upon, the performance of any preceding operation. Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A reconfigurable intelligent surface comprising: a substrate comprising a plurality of unit cells, wherein each of the unit cells comprises: a metal element formed on a first surface of the substrate and configured to be resonant with a frequency or a range of frequencies, a radio frequency component connected with the metal element, a bias line formed on a second surface of the substrate, and a capacitor bank connected to the bias line with a first switch, wherein the capacitor bank comprises selectable capacitors.

Embodiment 2. The reconfigurable intelligent surface of embodiment 1, wherein each of the selectable capacitors is associated with a second switch.

Embodiment 3. The reconfigurable intelligent surface of embodiment 1 and/or 2, wherein the first switch and each of the second switches comprises a material configured to change from a low resistive state to a high resistive state in response to a first voltage pulse and change from the high resistive state to the low resistive state in response to a second voltage pulse.

Embodiment 4. The reconfigurable intelligent surface of embodiment 1, 2, and/or 3, wherein the material comprises a chalcogenide material.

Embodiment 5. The reconfigurable intelligent surface of embodiment 1, 2, 3, and/or 4, wherein the selectable capacitors are configured to be selected in series or parallel.

Embodiment 6. The reconfigurable intelligent surface of embodiment 1, 2, 3, 4, and/or 5, wherein the capacitor bank is formed with respect to a ground plane on a first side of the bias line, further comprising a second capacitor bank formed with respect to the ground plane on a second side of the bias line.

Embodiment 7. The reconfigurable intelligent surface of embodiment 1, 2, 3, 4, 5, and/or 6, further comprising a plurality of capacitor banks, wherein each of the plurality of capacitor banks is connected to the bias line with a corresponding switch.

Embodiment 8. The reconfigurable intelligent surface of embodiment 1, 2, 3, 4, 5, 6, and/or 7, further comprising a second bias line.

Embodiment 9. The reconfigurable intelligent surface of embodiment 1, 2, 3, 4, 5, 6, 7, and/or 8, wherein the second bias line is connected with a capacitor bank through a third switch formed of a chalcogenide material.

Embodiment 10. The reconfigurable intelligent surface of embodiment 1, 2, 3, 4, 5, 6, 7, 8, and/or 9, wherein the radio frequency component comprises a PIN diode or a varactor diode.

Embodiment 11. The reconfigurable intelligent surface of embodiment 1, 2, 3, 4, 5, 6, 7, 8, 9, and/or 10, wherein the first bias line is configured to control an operation of the radio frequency component.

Embodiment 12. The reconfigurable intelligent surface of embodiment 1, 2, 3, 4, 5, 6, 7, 8, 9, 10, and/or 11, wherein the radio frequency component is configured to operate as a switch.

Embodiment 13. The reconfigurable intelligent surface of embodiment 1, 2, 3, 4, 5, 6, 7, 8, 9, 10, 11, and/or 12, further comprising vias connecting the radio frequency component to the bias line.

Embodiment 14. The reconfigurable intelligent surface of embodiment 1, 2, 3, 4, 5, 6, 7, 8, 9, 10, 11, 12, and/or 13, further comprising a controller configured to operate the switch and configured to select one or more capacitors in the capacitor bank, wherein the controller is configured to connect the selected one or more capacitors to the bias line.

Embodiment 15. The reconfigurable intelligent surface of embodiment 1, 2, 3, 4, 5, 6, 7, 8, 9, 10, 11, 12, 13, and/or 14, wherein the controller is configured to control the radio frequency components of the unit cells and the first switches of the unit cells individually.

Embodiment 16. A reconfigurable intelligent surface comprising: a substrate comprising a plurality of unit cells, wherein each of the unit cells comprises: a metal element formed on a first surface of the substrate and configured to be resonant with a frequency or a range of frequencies, a radio frequency component connected with the metal element, a first bias line formed on a second surface of the substrate, a second bias line formed on the second surface, a first capacitor bank connected to the first bias line with a first switch, wherein the second capacitor bank comprises selectable capacitors that are each associated with a switch, and a second capacitor bank connected to the second bias line with a second switch, wherein the second capacitor bank comprises selectable capacitors that are each associated with a switch.

Embodiment 17. The reconfigurable intelligent surface of embodiment 16, wherein the first switch, the second switch, the switches associated with the selectable capacitors of the first capacitor bank and the switches associated with the selectable capacitors of the second capacitor bank comprise a material configured to change from a low resistive state to a high resistive state in response to a first voltage pulse and change from the high resistive state to the low resistive state in response to a second voltage pulse.

Embodiment 18. The reconfigurable intelligent surface of embodiment 16 and/or 17, further comprising a controller configured to control states of the first switch, the second switch, the switches associated with the selectable capacitors of the first capacitor bank and the switches associated with the selectable capacitors of the second capacitor in order to achieve a particular impedance value.

Embodiment 19. The reconfigurable intelligent surface of embodiment 16, 17, 18, and/or 18, wherein the material comprises a chalcogenide material.

Embodiment 20. The reconfigurable intelligent surface of embodiment 16, 17, and/or 19, wherein the reconfigurable intelligent surface is a monolithic structure.

Embodiment 21. A non-transitory storage medium having stored therein instructions that are executable by one or more hardware processors to perform operations comprising the operations of any one or more of embodiments disclosed herein.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

As used herein, the term module, component, engine, agent, service, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

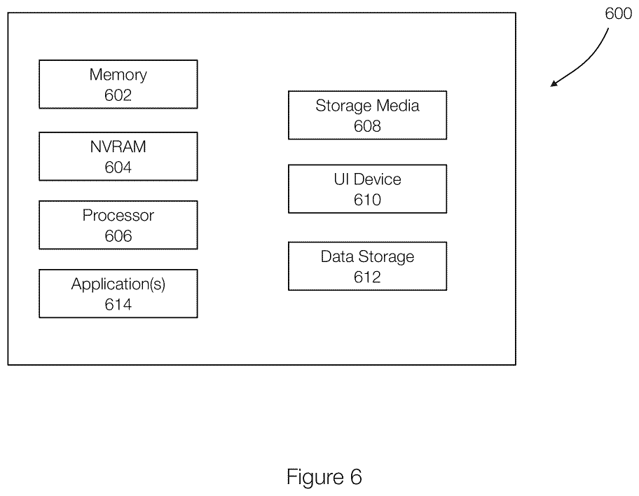

With reference briefly now to FIG. 6, any one or more of the entities disclosed, or implied, by the Figures and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A reconfigurable intelligent surface comprising:
a substrate comprising a plurality of unit cells, wherein each of the unit cells comprises:
a metal element formed on a first surface of the substrate and configured to be resonant with a frequency or a range of frequencies;
a radio frequency component connected with the metal element;
a bias line formed on a second surface of the substrate; and
a capacitor bank connected to the bias line with a first switch, wherein the capacitor bank comprises selectable capacitors.

2. The reconfigurable intelligent surface of claim 1, wherein each of the selectable capacitors is associated with a second switch.

3. The reconfigurable intelligent surface of claim 2, wherein the first switch and each of the second switches comprises a material configured to change from a low resistive state to a high resistive state in response to a first voltage pulse and change from the high resistive state to the low resistive state in response to a second voltage pulse.

4. The reconfigurable intelligent surface of claim 3, wherein the material comprises a chalcogenide material.

5. The reconfigurable intelligent surface of claim 1, wherein the selectable capacitors are configured to be selected in series or parallel.

6. The reconfigurable intelligent surface of claim 1, wherein the capacitor bank is formed with respect to a ground plane on a first side of the bias line, further comprising a second capacitor bank formed with respect to the ground plane on a second side of the bias line.

7. The reconfigurable intelligent surface of claim 1, further comprising a plurality of capacitor banks, wherein each of the plurality of capacitor banks is connected to the bias line with a corresponding switch.

8. The reconfigurable intelligent surface of claim 1, further comprising a second bias line.

9. The reconfigurable intelligent surface of claim 8, wherein the second bias line is connected with a capacitor bank through a third switch formed of a chalcogenide material.

10. The reconfigurable intelligent surface of claim 1, wherein the radio frequency component comprises a PIN diode or a varactor diode.

11. The reconfigurable intelligent surface of claim 1, wherein the first bias line is configured to control an operation of the radio frequency component.

12. The reconfigurable intelligent surface of claim 11, wherein the radio frequency component is configured to operate as a switch.

13. The reconfigurable intelligent surface of claim 1, further comprising vias connecting the radio frequency component to the bias line.

14. The reconfigurable intelligent surface of claim 1, further comprising a controller configured to operate the switch and configured to select one or more capacitors in the capacitor bank, wherein the controller is configured to connect the selected one or more capacitors to the bias line.

15. The reconfigurable intelligent surface of claim 14, wherein the controller is configured to control the radio frequency components of the unit cells and the first switches of the unit cells individually.

16. A reconfigurable intelligent surface comprising:
a substrate comprising a plurality of unit cells, wherein each of the unit cells comprises:
a metal element formed on a first surface of the substrate and configured to be resonant with a frequency or a range of frequencies;
a radio frequency component connected with the metal element;
a first bias line formed on a second surface of the substrate;
a second bias line formed on the second surface; and
a first capacitor bank connected to the first bias line with a first switch, wherein the second capacitor bank comprises selectable capacitors that are each associated with a switch;
a second capacitor bank connected to the second bias line with a second switch, wherein the second capacitor bank comprises selectable capacitors that are each associated with a switch.

17. The reconfigurable intelligent surface of claim 16, wherein the first switch, the second switch, the switches associated with the selectable capacitors of the first capacitor bank and the switches associated with the selectable capacitors of the second capacitor bank comprise a material configured to change from a low resistive state to a high resistive state in response to a first voltage pulse and change from the high resistive state to the low resistive state in response to a second voltage pulse.

18. The reconfigurable intelligent surface of claim 17, further comprising a controller configured to control states of the first switch, the second switch, the switches associated with the selectable capacitors of the first capacitor bank and the switches associated with the selectable capacitors of the second capacitor in order to achieve a particular impedance value.

19. The reconfigurable intelligent surface of claim 18, wherein the material comprises a chalcogenide material.

20. The reconfigurable intelligent surface of claim 17, wherein the reconfigurable intelligent surface is a monolithic structure.
